(19) United States
(12) Patent Application Publication
(10) Pub. No.: US 2026/0273972 A1
(43) Pub. Date: Sep. 17, 2026

(54) COLLECTING DEVICE FOR LASER PRINTER

(71) Applicant: Leica Biosystems Nussloch GmbH, Nussloch (DE)

(72) Inventors: Lester Lu, Shanghai (CN); Ming Wu, Shanghai (CN); Lisa Li, Shanghai (CN); Alex XIE, Shanghai (CN)

(21) Appl. No.: 19/168,218

(22) PCT Filed: Mar. 24, 2023
(86) PCT No.: PCT/CN2023/083847

§ 371 Date: Sep. 23, 2025

(51) Int. Cl. B41J 13/10; B41J 2/44; B41J 11/00; B41J 13/26; B41M 5/26; B65H 31/26; B65H 31/30; B65H 31/32; B65H 31/34; B65H 43/06

(52) U.S. Cl. CPC B41J 13/106; B41J 2/442; B41J 11/0095; B41J 13/26; B41M 5/26; B65H 31/26; B65H 31/3063; B65H 31/32; B65H 31/34; B65H 43/06; B65H 2301/4222; B65H 2301/42264; B65H 2801/15

(57) ABSTRACT

A collecting device for a laser printer includes an object carrier, an object stage, a pushing member and first and second drive assemblies. The object carrier is movable between first and second positions, in the first position the object carrier is configured to collect an object transferred from the laser printer in a first horizontal direction to form an object stack on the object carrier, and in the second position, the object stack is transferable from the object carrier onto the object stage in a second horizontal direction. The first drive assembly is configured to drive the object carrier to move between the first and second positions. The pushing member is configured to push the object stack from the object carrier onto the object stage in the second horizontal direction. The second drive assembly is configured to drive the pushing member to move in the second horizontal direction.

### CROSS REFERENCE TO RELATED APPLICATION

This application is a Section 371 National Stage Application of International Application No. PCT/CN2023/083847, filed on Mar. 24, 2023, entitled “COLLECTING DEVICE FOR LASER PRINTER”, which is incorporated herein by reference in its entirety.

### FIELD

The present disclosure relates to a field of laser-printing, and more particularly to a collecting device for a laser printer.

### BACKGROUND

In related art, collecting devices for laser printers generally may collect batch of slides or cassettes together. The collecting devices have small capacity, cannot align the slides or cassettes automatically, and cannot separate slides or cassettes for different purposes.

### SUMMARY

Embodiments of the present disclosure seek to solve at least one of the problems existing in the related art to at least some extent.

The present disclosure proposes a collecting device for a laser printer, which has improved capacity, can align objects automatically, and can separate objects for different purposes.

The present disclosure also proposes a laser printer including the above-mentioned collecting device.

The present disclosure also proposes a method for using the above-mentioned laser printer.

A collecting device for a laser printer according to embodiments of a first aspect of the present disclosure includes an object carrier, a first drive assembly, an object stage, a pushing member and a second drive assembly. The object carrier is movable between a first position and a second position lower than the first position in a vertical direction, and in the first position the object carrier is configured to collect at least one object transferred from the laser printer in a first horizontal direction to form an object stack on the object carrier. The first drive assembly is configured to drive the object carrier to move between the first position and the second position. In the second position, the object stack is transferable from the object carrier onto the object stage in a second horizontal direction. The pushing member is configured to push the object stack from the object carrier in the second position onto the object stage in the second horizontal direction. The second drive assembly is configured to drive the pushing member to move in the second horizontal direction.

In the collecting device according to embodiments of the present disclosure, provision of the object carrier and the object stage facilitates collection of a large number of objects automatically, to improve printing efficiency.

In some embodiments, the collecting device further includes an alignment assembly located at the object stage and configured align the at least one object in the object stack when the object stack is pushed from the object carrier in the second position onto the object stage in the second horizontal direction. Thus, the at least one object in the object stack may be aligned in the second horizontal direction by the alignment assembly automatically.

The object stage includes: a carrying plate extending in the second horizontal direction, and a guard plate extending in the vertical direction and coupled at a side of the carrying plate in the first horizontal direction and opposite to the alignment assembly. Thus, the object stage may have a simple structure and collect a large number of object stacks, and the guard plate may assist the alignment assembly in alignment of the at least one object in the object stack.

The alignment assembly includes three rollers oriented in the vertical direction and spaced apart from one another in the second horizontal direction; and the three rollers are arranged at a side of the carrying plate opposite to the guard plate in the first horizontal direction. Thus, the alignment assembly may have a simple structure and better align the at least one object in the object stack.

In some embodiments, the collecting device further includes a pressure assembly located at the object carrier in the first position, and configured to generate pressure on a top of the object stack collected on the object carrier under gravity. Thus, the at least one object collected on the object carrier may be prevented from turning over when another object is transferred onto the object carrier.

The pressure assembly includes: a mounting plate defining two holes, two cylinders slidably mounted in the two holes respectively, and a pressing plate coupled to bottom ends of the two cylinders, the pressing plate being configured to generate pressure on the top of the object stack collected on the object carrier under gravity. Thus, when another object is transferred onto the object carrier, the pressing plate supply a force to prevent objects 900 from bouncing widely or turning over.

In some embodiments, the collecting device further includes a guidance assembly located at the object carrier in the first position and configured to guide the at least one object transferred from the laser printer onto the object carrier. Thus, the object may be transferred onto the object carrier easily, and furthermore, the objects may be substantially aligned in the first horizontal direction.

In some embodiments, the collecting device further includes a protection plate located at the object carrier in the first position and attached to at least one of the guide assembly and the pressure assembly, and configured to prevent retreat of the at least one object collected on the object carrier from the object carrier in the first horizontal direction. Thus, the at least one object collected on the object carrier may be prevented from retreating from the object carrier in the first horizontal direction.

In some embodiments, the collecting device further includes a stack height sensor located at the object carrier in the first position and configured to determine whether a height of the object stack on the object carrier reaches a preset height. That is, the stack height sensor may be used to determine whether the object carrier is full.

In some embodiments, the first drive assembly includes: a first motor having an output end; a first screw rod coupled to the output end; a first nut fitted over the first screw rod, the first screw rod and the first nut being configured to translate turning motion of the first screw rod into linear motion of the first nut in the vertical direction, the first nut being coupled to the object carrier; a first guide rail oriented in the vertical direction; and a first slide block is slidably arranged on the first guide rail and fixedly coupled to the first nut. Thus, the object carrier may be moved between the first position and the second position automatically.

In some embodiments, the first drive assembly includes: a first position sensor located at the object carrier in the first position; a second position sensor located at the object carrier in the second position; and a first trigger plate coupled to the object carrier and movable with the object carrier, and configured to trigger the first position sensor when the object carrier is in the first position and trigger the second position sensor when the object carrier is in the second position. Thus, by means of the first position, the second position and the first trigger plate, the object carrier may be located in the first position or the second position accurately.

In some embodiments, the object carrier includes: a bearing plate extending in the first horizontal direction and configured to carry the at least one object from the laser printer, the bearing plate having a first end and a second end opposite to each other in the first horizontal direction, the at least one object being transferrable onto the bearing plate from the first end; and a coupling plate extending in the vertical direction and coupled to the second end of the bearing plate, and coupled to the first drive assembly. The bearing plate defines a slope surface at the first end of the bearing plate. Thus, the object carrier has a simple structure. Additionally, by means of the slope surface, an object may be transferred from the laser printer and interposed between the bearing plate and a bottom object in the object stack, achieving an effect of first-in first-out for the objects.

In some embodiments, the pushing member is movable between an original position and an end position in the second horizontal direction, in the original position, the pushing member is located a side of the object carrier in the second position away from the object stage, and in the end position, the pushing member is located on the object stage and beyond the alignment assembly. Thus, when in the original position, the pushing member may be ready for pushing the object stack on the object carrier in the second position towards the object stage; and when in the end position, the object stack may be passed through the alignment assembly thoroughly for alignment.

In some embodiments, the second drive assembly includes: a third position sensor located at the pushing member in the original position; a fourth position sensor located at the pushing member in the end position; and a second trigger plate coupled to the pushing member and movable with the pushing member, and configured to trigger the third position sensor when the pushing member is in the original position and trigger the fourth position sensor when the pushing is in the end position. Thus, the pushing member may be located at the original position or the end position accurately.

In some embodiments, the second drive assembly includes: a second motor having an output end; a second screw rod coupled to the output end; a second nut fitted over the second screw rod, the second screw rod and the second nut being configured to translate turning motion of the second screw rod into linear motion of the second nut in the second horizontal direction, and the second nut being coupled to the pushing member; a second guide rail oriented in the second horizontal direction; and a second slide block is slidably arranged on the second guide rail and fixedly coupled to the second nut. Thus, the object stack may be transferred from the object carrier onto the object stage automatically.

A laser printer according to embodiments of a second aspect of the present disclosure includes a collecting device according to any one of the above-described embodiments; a laser generator configured to laser-print an object; and a printing area located below the laser generator in the vertical direction and configured to carry the object. The collecting device is located at a side of the printing area in the first horizontal direction.

In the laser printer according to embodiments of the present disclosure, provision of the object carrier and the object stage facilitates collection of a large number of objects automatically, to improve printing efficiency of the laser printer.

A method for using a laser printer according to embodiments of a third aspect of the present disclosure includes: laser-printing an object and transferring the object to the object carrier to form an object stack on the object carrier; and in response to determining that the object carrier is full or a single task of laser-printing a same type of objects is completed, unloading the object stack from the object carrier to the object stage.

In the method for using the laser printer according to embodiments of the present disclosure, the objects for different purposes may be separated and stacked in different object stacks automatically. That is, the objects may be separated based on tasks automatically for better usability.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a front view of a laser printer according to an embodiment of the present disclosure;

FIG. 2 is a front, top, left view of a laser printer according to an embodiment of the present disclosure;

FIG. 3 is a front, top, right view of a laser printer according to an embodiment of the present disclosure;

FIG. 4 is a left view of a laser printer according to an embodiment of the present disclosure;

FIG. 5 is a schematic view of a magazine according to an embodiment of the present disclosure; and

FIG. 6 is a schematic view of a collector according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present disclosure, “a plurality of” means two or more than two, unless specified otherwise.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications or interactions of two elements, which can be understood by those skilled in the art according to specific situations.

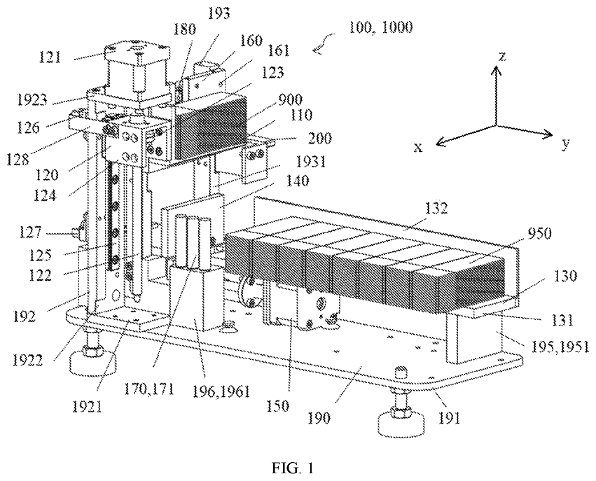

In FIGS. 1 to 5, the orthogonal XYZ-axis is illustrated in order to facilitate the description and determine the directions. In which, the positive direction of the X-axis is the front direction and the negative direction of the X-axis is the rear direction (i.e., a first horizontal direction); the positive direction of the Y-axis is the right direction and the negative direction of the Y-axis is the left direction (i.e., a second horizontal direction); the positive direction of the Z-axis is the top direction and the negative direction of the Z-axis bottom direction (i.e., a vertical direction).

A collecting device 100 for a laser printer 1000 according to embodiments of the present disclosure will be described below with reference to FIGS. 1 to 6.

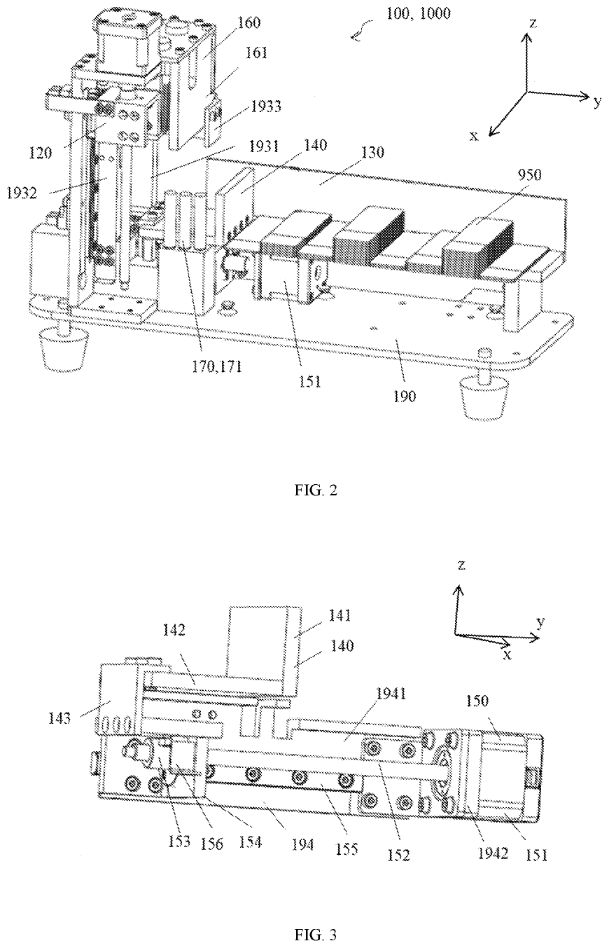

As illustrated in FIGS. 1 and 2, a collecting device 100 for a laser printer 1000 according to embodiments of a first aspect of the present disclosure includes an object carrier 110, a first drive assembly 120, an object stage 130, a pushing member 140 and a second drive assembly 150. The object carrier 110 is movable between a first position and a second position lower than the first position in a vertical direction, and in the first position the object carrier 110 is configured to collect at least one object 900 transferred from the laser printer 1000 in a first horizontal direction to form an object stack 950 on the object carrier 110. The first drive assembly 120 is configured to drive the object carrier 110 to move between the first position and the second position. In the second position, the object stack 950 is transferable from the object carrier 110 onto the object stage 130 in a second horizontal direction. The pushing member 140 is configured to push the object stack 950 from the object carrier 110 in the second position onto the object stage 130 in the second horizontal direction. The second drive assembly 150 is configured to drive the pushing member 140 to move in the second horizontal direction.

In the collecting device 100 according to embodiments of the present disclosure, provision of the object carrier 110 and the object stage 130 facilitates collection of a large number of objects 900 automatically, to improve printing efficiency.

It should note that the object 900 in the present disclosure may have a flat or sheet structure and substantially a rectangular or square shape. For example, in the histopathology, the object 900 may include a slide or a cassette.

In some embodiments, as illustrated in FIGS. 1 and 2, the collecting device 100 further includes an alignment assembly 170 located at the object stage 130 and configured align the at least one object 900 in the object stack 950 when the object stack 950 is pushed from the object carrier 110 in the second position onto the object stage 130 in the second horizontal direction. Thus, the at least one object 900 in the object stack 950 may be aligned in the second horizontal direction by the alignment assembly 170 automatically.

As illustrated in FIGS. 1 and 2, the object stage 130 includes: a carrying plate 131 extending in the second horizontal direction, and a guard plate 132 extending in the vertical direction and coupled at a side of the carrying plate 131 in the first horizontal direction and opposite to the alignment assembly 170. Thus, the object stage may have a simple structure and collect a large number of object stacks 950, and the guard plate 132 may assist the alignment assembly 170 in alignment of the at least one object 900 in the object stack 950.

As illustrated in FIGS. 1 and 2, the alignment assembly 170 includes three rollers 171 oriented in the vertical direction and spaced apart from one another in the second horizontal direction; and the three rollers 171 are arranged at a side of the carrying plate 131 opposite to the guard plate 132 in the first horizontal direction. Thus, the alignment assembly 170 may have a simple structure and better align the at least one object 900 in the object stack 950.

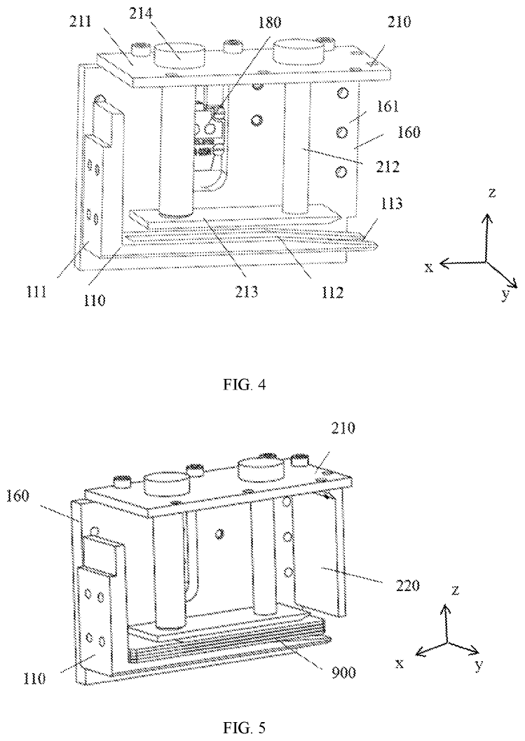

In some embodiments, as illustrated in FIGS. 4 and 5, the collecting device 100 further includes a pressure assembly 210 located at the object carrier 110 in the first position, and configured to generate pressure on a top of the object stack 950 collected on the object carrier 110 under gravity. Thus, the at least one object 900 collected on the object carrier 110 may be prevented from turning over when another object 900 is transferred onto the object carrier 110.

As illustrated in FIGS. 4 and 5, the pressure assembly 210 includes: a mounting plate 211 defining two holes, two cylinders 212 slidably mounted in the two holes respectively, and a pressing plate 213 coupled to bottom ends of the two cylinders 212, the pressing plate 213 being configured to generate pressure on the top of the object stack 950 collected on the object carrier 110 under gravity. Thus, when another object 900 is transferred onto the object carrier 110, the pressing plate 213 supply a force to prevent objects 900 from bouncing widely or turning over.

In some embodiments, as illustrated in FIGS. 1 and 2, the collecting device 100 further includes a guidance assembly 160 located at the object carrier 110 in the first position and configured to guide the at least one object 900 transferred from the laser printer 1000 onto the object carrier 110. Thus, the object 900 may be transferred onto the object carrier 110 easily, and furthermore, the objects 900 may be substantially aligned in the first horizontal direction.

For example, the guidance assembly 160 may include two guidance plates 161 respectively located at two sides of the object carrier 110 in the second horizontal direction. A distance between the two guidance plates 161 may be substantially equal to a size of the object 900 in the second horizontal direction, to align the object stack 950 in the first horizontal direction.

Furthermore, the pressure assembly 210 is attached to the guidance assembly 160. Specifically, the mounting plate 211 of the pressure assembly 210 is attached to at least one of the two guidance plates 161 of the guidance assembly 160. Thus, the collecting device 100 may have a compact structure.

In some embodiments, as illustrated in FIG. 5, the collecting device 100 further includes a protection plate 220 located at the object carrier 110 in the first position and attached to at least one of the guide assembly and the pressure assembly, and configured to prevent retreat of the at least one object 900 collected on the object carrier 110 from the object carrier 110 in the first horizontal direction. Thus, the at least one object 900 collected on the object carrier 110 may be prevented from retreating from the object carrier 110 in the first horizontal direction.

In some embodiments, as illustrated in FIGS. 1 and 4, the collecting device 100 further includes a stack height sensor 180 located at the object carrier 110 in the first position and configured to determine whether a height of the object stack 950 on the object carrier 110 reaches a preset height. That is, the stack height sensor 180 may be used to determine whether the object carrier 110 is full.

In some embodiments, as illustrated in FIGS. 1 and 2, the first drive assembly 120 includes: a first motor 121 having an output end; a first screw rod 122 coupled to the output end; a first nut 123 fitted over the first screw rod 122, the first screw rod 122 and the first nut 123 being configured to translate turning motion of the first screw rod 122 into linear motion of the first nut 123 in the vertical direction, the first nut 123 being coupled to the object carrier 110; a first guide rail 125 oriented in the vertical direction; and a first slide block 124 is slidably arranged on the first guide rail 125 and fixedly coupled to the first nut 123. Thus, the object carrier 110 may be moved between the first position and the second position automatically.

In some embodiments, as illustrated in FIGS. 1 and 2, the first drive assembly 120 includes: a first position sensor 126 located at the object carrier 110 in the first position; a second position sensor 127 located at the object carrier 110 in the second position; and a first trigger plate 128 coupled to the object carrier 110 and movable with the object carrier 110, and configured to trigger the first position sensor 126 when the object carrier 110 is in the first position and trigger the second position sensor 127 when the object carrier 110 is in the second position. Thus, by means of the first position, the second position and the first trigger plate 128, the object carrier 110 may be located in the first position or the second position accurately.

In some embodiments, as illustrated in FIGS. 4 and 5, the object carrier 110 includes: a bearing plate 112 extending in the first horizontal direction and configured to carry the at least one object 900 from the laser printer 1000, the bearing plate 112 having a first end and a second end opposite to each other in the first horizontal direction, the at least one object 900 being transferrable onto the bearing plate 112 from the first end; and a coupling plate 111 extending in the vertical direction and coupled to the second end of the bearing plate 112, and coupled to the first drive assembly 120. The bearing plate 112 defines a slope surface 113 at the first end of the bearing plate 112. Thus, the object carrier 110 has a simple structure. Additionally, by means of the slope surface 113, an object 900 may be transferred from the laser printer 1000 and interposed between the bearing plate 112 and a bottom object 900 in the object stack 950, achieving an effect of first-in first-out for the objects 900.

In some embodiments, as illustrated in FIGS. 1 and 3, the pushing member 140 is movable between an original position and an end position in the second horizontal direction, in the original position, the pushing member 140 is located a side of the object carrier 110 in the second position away from the object stage 130, and in the end position, the pushing member 140 is located on the object stage 130 and beyond the alignment assembly 170. Thus, when in the original position, the pushing member 140 may be ready for pushing the object stack 950 on the object carrier 110 in the second position towards the object stage 130; and when in the end position, the object stack 950 may be passed through the alignment assembly 170 thoroughly for alignment.

In some embodiments, as illustrated in FIGS. 1 and 3, the second drive assembly 150 includes: a third position sensor located at the pushing member 140 in the original position; a fourth position sensor located at the pushing member 140 in the end position; and a second trigger plate 156 coupled to the pushing member 140 and movable with the pushing member 140, and configured to trigger the third position sensor when the pushing member 140 is in the original position and trigger the fourth position sensor when the pushing is in the end position. Thus, the pushing member 140 may be located at the original position or the end position accurately.

In some embodiments, as illustrated in FIGS. 1 and 3, the second drive assembly 150 includes: a second motor 151 having an output end; a second screw rod 152 coupled to the output end; a second nut 153 fitted over the second screw rod 152, the second screw rod 152 and the second nut 153 being configured to translate turning motion of the second screw rod 152 into linear motion of the second nut 153 in the second horizontal direction, and the second nut 153 being coupled to the pushing member 140; a second guide rail 155 oriented in the second horizontal direction; and a second slide block 154 is slidably arranged on the second guide rail 155 and fixedly coupled to the second nut 153. Thus, the object stack 950 may be transferred from the object carrier 110 onto the object stage 130 automatically.

As illustrated in FIGS. 1 and 2, a laser printer 1000 according to embodiments of a second aspect of the present disclosure includes a collecting device 100 according to any one of the above-described embodiments; a laser generator configured to laser-print an object 900; and a printing area located below the laser generator in the vertical direction and configured to carry the object 900. The collecting device 100 is located at a side of the printing area in the first horizontal direction.

In the laser printer 1000 according to embodiments of the present disclosure, provision of the object carrier 110 and the object stage 130 facilitates collection of a large number of objects 900 automatically, to improve printing efficiency of the laser printer 1000.

It should note that the object 900 is laser-printed and transferred onto the object carrier 110 one by one. That is, an object 900 is laser-printed and then transferred onto the object carrier 110, and then another object 900 is laser-printed and then transferred onto the object carrier 110, and so on.

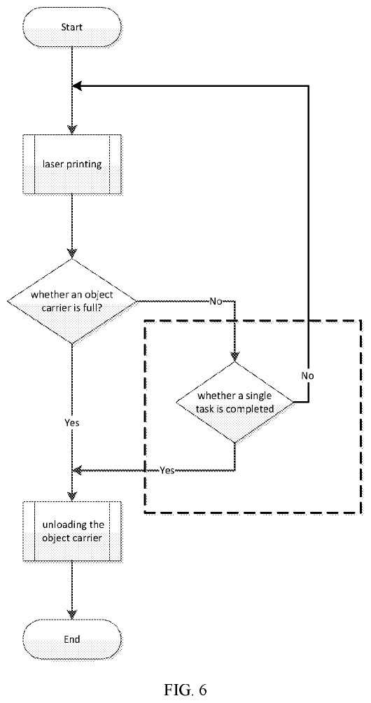

As illustrated in FIG. 6, a method for using a laser printer 1000 according to embodiments of a third aspect of the present disclosure includes: laser-printing an object 900 and transferring the object 900 to the object carrier 110 to form an object stack 950 on the object carrier 110; and in response to determining that the object carrier 110 is full or a single task of laser-printing a same type of objects 900 is completed, unloading the object stack 950 from the object carrier 110 to the object stage 130.

In the method for using the laser printer 1000 according to embodiments of the present disclosure, the objects 900 for different purposes may be separated and stacked in different object stacks 950 automatically. That is, the objects 900 may be separated based on tasks automatically for better usability.

In some embodiments, in response to determining that the object carrier 110 is full or a single task of laser-printing a same type of objects 900 is completed, unloading the object stack 950 from the object carrier 110 to the object stage 130 includes: in response to determining that the object carrier 110 is full, unloading the object stack 950 from the object carrier 110 to the object stage 130; or in response to determining that the object carrier 110 is not full and the single task of laser-printing the same type of objects 900 is completed, unloading the object stack 950 from the object carrier 110 to the object stage 130. Thus, the same type of objects 900 may be collected in the same object stack 950 or adjacent object stacks 950, and different types of objects 900 may be collected in different object stacks 950.

A collecting device 100 for a laser printer 1000 according to an embodiment of the present disclosure will be described in detail below with reference to FIGS. 1 to 6.

As illustrated in FIGS. 1 and 2, the collecting device 100 includes an object carrier 110, a first drive assembly 120, an object stage 130, a pushing member 140, a second drive assembly 150, a guidance assembly 160, an alignment assembly 170, a stack height sensor 180, a frame 190, and a connector 200.

The frame 190 includes a base portion 191, a first mounting portion 192, a second mounting portion 193, a third mounting portion 194, a fourth mounting portion 195 and a fifth mounting portion 196.

The base portion 191 has a substantially plate shape, and first to fifth mounting portions 192-196 are mounted on the base portion 191. The first mounting portion 192 is configured to mount the first drive assembly 120, the second mounting portion 193 is configured to mount the guidance assembly 160 and the connector 200, the third mounting portion 194 is configured to mount the second drive assembly 150, the fourth mounting portion 195 is configured to mount the object stage 130, and the fifth mounting portion 196 is configured to mount alignment assembly 170.

The object carrier 110 is mounted on the frame 190 and movable between a first position and a second position lower than the first position in a top-bottom direction. In the first position, the object carrier 110 is configured to collect at least one object 900 from a laser printer 1000 in a stacked manner, and the at least one object 900 is transferred onto the object carrier 110 in a front-rear direction. For example, each time the laser printer 1000 laser-prints an object 900 and transfer it onto the object carrier 110, and the collected objects 900 are stacked on the object carrier 110. In the second position, the at least one object 900 collected on the object carrier 110 is transferable onto the object stage 130.

As illustrated in FIGS. 4 and 5, the object carrier 110 includes a coupling plate 111 and a bearing plate 112. The bearing plate 112 extends in the front-rear direction, and the coupling plate 111 extends in the top-bottom direction and coupled to a front side of the bearing plate 112. The coupling plate 111 is configured to couple to the first drive assembly 120. The bearing plate 112 is configured to collect the object 900 from the laser printer 1000.

The bearing plate 112 defines a slope surface 113 at a rear side of the bearing plate 112. Thus, a new object 900 from the laser printer 1000 may be inserted between a bottom object 900 stacked on the object carrier 110 and a top surface of the object carrier 110 by means of the slope surface 113. That is, a new object 900 is always located at bottommost in the object carrier 110, achieving an effect of first-in first-out.

As illustrated in FIGS. 1 and 2, the first drive assembly 120 is mounted on the frame 190 and configured to drive the object carrier 110 to move between the first position and the second position.

The first drive assembly 120 includes a first motor 121, a first screw rod 122, a first nut 123, a first slide block 124 and a first guide rail 125. The first motor 121 has an output end coupled to the first screw rod 122. The first nut 123 is fitted over the first screw rod 122. The first screw rod 122 and the first nut 123 are configured to translate turning motion of the first screw rod 122 into linear motion of the first nut 123 in the top-bottom direction. The first guide rail 125 is oriented in the top-bottom direction, and the first slide block 124 is slidably arranged on the first guide rail 125 and fixedly coupled to the first nut 123. Thus, the rotation of the first nut 123 around the first screw rod 122 is restrained.

The object carrier 110 is fixedly coupled to the first nut 123. Thus, the object carrier 110 may move linearly in the top-bottom direction.

The first drive assembly 120 further includes a first position sensor 126, a second position sensor 127 and a first trigger plate 128. The first position sensor 126 and the second position sensor 127 are spaced apart in the top-bottom direction. The first trigger plate 128 is fixedly coupled to the first nut 123, thus is movable in the top-bottom direction along with the object carrier 110. The first position sensor 126 is configured to determine whether the object carrier 110 is located at the first position, the second position sensor 127 is configured to determine whether the object carrier 110 is located at the second position, and the first trigger plate 128 is configured to trigger the first position sensor 126 when the object carrier 110 is located at the first position, and trigger the second position sensor 127 when the object carrier 110 is located at the second position.

The first mounting portion 192 includes a first horizontal plate 1921, a first vertical plate 1922, and a second horizontal plate 1923. The first horizontal plate 1921 is coupled at a front edge of the base portion 191 and near a left edge of the base portion 191, the first vertical plate 1922 is coupled to a left side of the first horizontal plate 1921, and the second horizontal plate 1923 is coupled to a top side of the first vertical plate 1922.

The first motor 121 is mounted to the second horizontal plate 1923, the first guide rail 125 is mounted to the first vertical plate 1922, and the first position sensor 126 and the second position sensor 127 are mounted to the first vertical plate 1922.

The guidance assembly 160 is mounted on the frame 190 and over the object carrier 110 in the first position, and configured to guide or limit the object 900 transferred onto the object carrier 110.

The guidance assembly 160 includes two guidance plates 161 arranged at left and right sides of the object carrier 110 respectively. Thus, the objects 900 may be smoothly guided onto the object carrier 110 and long sides of the objects 900 may be substantially aligned by the two guidance plates 161.

The second mounting portion 193 includes a first mounting post 1931 coupled at a rear side of the base portion 191 and near the left edge of the base portion 191, a second mounting post 1932 spaced apart from the first mounting post 1931 and near the first mounting portion 192, and a first bent plate 1933 coupled to the first mounting post 1931. The left guidance plate 161 is mounted to the first mounting post 1931 and the second mounting post 1932, and the right guidance plate 161 is mounted to the first bent plate 1933.

As illustrated in FIGS. 4 and 5, the collecting device 100 further includes a pressure assembly 210 attached to the guidance assembly 160 and configured to prevent turnover of the object 900 collected on the object carrier 110 when a new object 900 is transferred onto the object carrier 110. The pressure assembly 210 includes a mounting plate 211 defining two holes, two cylinders 212 slidably mounted in the two holes respectively, and a pressing plate 213 coupled to bottom ends of the cylinders 212. The pressing plate 213 is configured to generate pressure on a top of the object stack 950 collected on the object carrier 110 under gravity, to prevent the at least one object 900 in the object stack 950 from bouncing widely or turning over when a new object 900 is transferred onto the object carrier 110.

Each of the two cylinders 212 has a flange 214 formed at a top end to prevent the cylinders 212 from escaping from the respective holes under gravity.

As illustrated in FIG. 5, the collecting device 100 further includes a protection plate 220 coupled to a bottom side of mounting plate 211 and near a rear side of the mounting plate 211. The protection plate 220 is configured to prevent retreat of the object 900 collected on the object carrier 110 from the object carrier 110 when a new object 900 is transferred onto the object carrier 110.

As illustrated in FIG. 3, the pushing member 140 is mounted on the frame 190 and movable between an original position and an end position in the left-right direction, and configured to push the object stack 950 from the object carrier 110 onto the object stage 130 through the alignment assembly 170. In the original position, the pushing member 140 is located a right side of the object carrier 110 in the second position. In the end position, the pushing member 140 is located on the object stage 130 and beyond the alignment assembly 170.

The second drive assembly 150 is mounted on the frame 190 and configured to drive the pushing member 140 to move between the original position and the end position.

The second drive assembly 150 includes a second motor 151, a second screw rod 152, a second nut 153, a second slide block 154 and a second guide rail 155. The second motor 151 has an output end coupled to the second screw rod 152. The second nut 153 is fitted over the second screw rod 152. The second screw rod 152 and the second nut 153 are configured to translate turning motion of the second screw rod 152 into linear motion of the second nut 153 in the top-bottom direction. The second guide rail 155 is oriented in the left-right direction, and the second slide block 154 is slidably arranged on the second guide rail 155 and fixedly coupled to the second nut 153. Thus, the rotation of the second nut 153 around the second screw rod 152 is restrained.

The pushing member 140 is fixedly coupled to the second nut 153. Thus, the pushing member 140 may move linearly in the left-right direction between the original position and the end position. The pushing member 140 includes a pushing plate 141, a first connection pate 142, and a second connection plate 143. The pushing plate 141 is oriented in the top-bottom direction, and has a bottom edge coupled to a right side of the first connection plate 142. The first connection plate 142 is a flat plate, and has a left side coupled to an upper portion of the second connection plate 143. The second connection plate 143 is a bent plate, and has a lower portion coupled to the second slide block 154.

The second drive assembly 150 further includes a third position sensor, a fourth position sensor and a second trigger plate 156. The third position sensor and the fourth position sensor are spaced apart in the left-right direction. The second trigger plate 156 is fixedly coupled to the second nut 153, thus is movable in the left-right direction along with the pushing member 140. The third position sensor is configured to determine whether the pushing member 140 is located at the original position, the fourth position sensor is configured to determine whether the pushing member 140 is located at the end position, and the second trigger plate 156 is configured to trigger the third position sensor when the pushing member 140 is located at the original position, and trigger the fourth position sensor when the pushing member 140 is located at the end position.

As illustrated in FIGS. 1 and 2, the third mounting portion 194 includes a second vertical plate 1941 and a second bent plate 1942. The second vertical plate 1941 extends in the left-right direction, and the second bent plate 1942 is coupled to a right side of the second vertical plate 1941. The second motor 151 is mounted to the second bent plate 1942, and the second guide rail 155 is mounted on the second vertical plate 1941.

The object stage 130 is mounted on the frame 190 and configured to collect object stack 950 from the object carrier 110.

The object stage 130 includes a carrying plate 131 extending horizontally in the left-right direction, and a guard plate 132 extending vertically in the top-bottom direction and at a rear side of the carrying plate 131.

The fourth mounting portion 195 includes a first boss 1951 coupled to the base portion 191. The carrying plate 131 is mounted on a top of the first boss 1951. The first boss 1951 is located at a rear edge of the base portion 191 and near a right edge of the base portion 191. The carrying plate 131 is also mounted to the second vertical plate 1941 of the third mounting portion 194. Hence, the object stage 130 is stably supported by the fourth mounting portion 195 and the third mounting portion 194.

The alignment assembly 170 is mounted on the frame 190 and at a front side of the object stage 130, and configured to align the at least one object 900 when the at least one object 900 is pushed from the object carrier 110 in the second position to the object stage 130 and passed through the alignment assembly 170.

The alignment assembly 170 includes three rollers 171 oriented in the top-bottom direction and spaced apart from one another in the left-right direction. The three rollers 171 are arranged at a front side of the carrying plate 131 and opposite to the guard plate 132.

The fifth mounting portion 196 includes a second boss 1961 coupled to the base portion 191. The three rollers 171 are rotatably mounted on the second boss 1961. The second boss 1961 is located at a right side of the first mounting portion 192 and at a front side of the third mounting portion 194.

As illustrated in FIGS. 1 and 4, the stack height sensor 180 is mounted at a right side of the object carrier 110 in the first position and configured to determine whether a height of the object stack 950 on the object carrier 110 reaches a preset height. In other words, the stack height sensor 180 defines a full state of the object carrier 110.

For example, when the height of the object stack 950 on the object carrier 110 reaches the preset height, the stack height sensor 180 detects the object stack 950, and sends a signal to a controller of the laser printer 1000 or the collecting device 100. In responses to the signal, the controller controls the laser printer 1000 to stop laser printing, and controls the object carrier 110 to move from the first position to the second position.

The connector 200 is mounted on the frame 190 and configured to couple to the laser printer 1000, to ensure accurate relative position of the collecting device 100 and the laser printer 1000.

A work process of the collecting device 100 according to an embodiment of the present disclosure is described below with reference to FIGS. 1 to 5.

Each time, an object 900 is transferred onto the object carrier 110 in the first position in the front-rear direction, and located at bottommost on the object carrier 110 to form an object stack 950.

When the stack height sensor 180 detects a top of the object stack 950, the stack height sensor 180 sends a signal to a controller of the collecting device 100. In response to the signal, the controller controls the first drive assembly 120 to drive the object carrier 110 to move from the first position to the second position.

When the second position sensor 127 detects the first trigger plate 128, the second position sensor 127 sends a signal to the controller. In response to the signal, the controller controls the second drive assembly 150 to drive the pushing member 140 to move from the original position to the end position through the alignment assembly 170. Thus, the object stack 950 is transferred onto the object stage 130.

When the fourth position sensor detects the second trigger plate 156, the fourth position sensor sends a signal to the controller. In response to the signal, the controller controls the first drive assembly 120 to drive the object carrier 110 to move from the second position to the first position.

When the first position sensor 126 detects the first trigger plate 128, the first position sensor 126 sends a signal to the controller. In response to the signal, the controller controls the second drive assembly 150 to drive the pushing member 140 to move from the end position to the original position.

When the third position sensor detects the second trigger plate 156, the third position sensor sends a signal to the controller. In response to the signal, the controller allows the object carrier 110 to move from the first position to the second position in a next cycle.

For example, as illustrated in the figures, the object carrier 110 may collect twenty five slides, and the object stage 130 may collect eight slide stacks. Thus, the collecting device 100 as shown may collect two hundred slides. The collecting device 100 according to the present disclosure may have a large capacity and align the objects 900 automatically.

As illustrated in FIGS. 1 and 2, a laser printer 1000 according to embodiments of the present disclosure includes a laser generator configured to laser-print an object 900, a printing area located below the laser generator configured to carry the object 900 for laser printing, and a collecting device 100 according to any one of the above-described embodiments. The collecting device 100 is arranged at a side of the printing area and configured to collect the object 900 from the printing area.

A method for using a laser printer 1000 including a collecting device 100 according to any one of the above described embodiments will be described below with reference to FIG. 6.

An object 900 is laser printed and transferred onto an object carrier 110 in a stacked manner.

Whether the object carrier 110 is full is determined.

In response to the object carrier 110 is full, the objects 900 are unloaded from the object carrier 110 to an object stage 130.

In response to the object carrier 110 is not full, whether a single task of laser-printing a same type of objects 900 is completed is determined.

In response to the single task is completed, the objects 900 are unloaded from the object carrier 110 to the object stage 130.

In response to the single task is not completed, the step of laser-printing and transferring an object 900 is restarted.

For example, thirty slides of a first type are to be printed, and twenty slides of a second type are to be printed. According to the above-described method for using the laser printer 1000, when twenty five slides of the first type are stacked on the object carrier 110 (the object carrier 110 is full), the object carrier 110 is unloaded; and then when remaining five slides of the first type (the single task of laser-printing the slides of the first type is completed) are stacked on the object carrier 110, the object carrier 110 is unloaded. Furthermore, when the twenty slides of the second type are stacked on the object carrier 110, the object carrier 110 is unloaded. Thus, the slides of different types are separated automatically.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

### REFERENCE NUMERALS

1000 laser printer
100 collecting device
110 object carrier
111 coupling plate
112 bearing plate
113 slope surface
120 first drive assembly
121 first motor
122 first screw rod
123 first nut
124 first slide block
125 first guide rail
126 first position sensor
127 second position sensor
128 first trigger plate
130 object stage
131 carrying plate
132 guard plate
140 pushing member
141 pushing plate
142 first connection pate
143 second connection plate
150 second drive assembly
151 second motor
152 second screw rod
153 second nut
154 second slide block
155 second guide rail
156 second trigger plate
160 guidance assembly
161 guidance plate
170 alignment assembly
171 roller
180 stack height sensor
190 frame
191 base portion
192 first mounting portion
1921 first horizontal plate
1922 first vertical plate
1923 second horizontal plate
193 second mounting portion
1931 first mounting post
1932 second mounting post
1933 first bent plate
194 third mounting portion
1941 second vertical plate
1942 second bent plate
195 fourth mounting portion
1951 first boss
196 fifth mounting portion
1961 second boss
200 connector
210 pressure assembly
211 mounting plate
212 cylinder
213 pressing plate
214 flange
220 protection plate

1. A collecting device for a laser printer, comprising:
an object carrier movable between a first position and a second position lower than the first position in a vertical direction, in the first position the object carrier being configured to collect at least one object transferred from the laser printer in a first horizontal direction to form an object stack on the object carrier;
a first drive assembly configured to drive the object carrier to move between the first position and the second position;
an object stage, configured such that in the second position of the object carrier, the object stack is transferable from the object carrier onto the object stage in a second horizontal direction;
a pushing member configured to push the object stack from the object carrier in the second position onto the object stage in the second horizontal direction; and
a second drive assembly configured to drive the pushing member to move in the second horizontal direction.

2. The collecting device according to claim 1, further comprising:
an alignment assembly located at the object stage and configured to align the at least one object in the object stack when the object stack is pushed from the object carrier in the second position onto the object stage in the second horizontal direction;
wherein the object stage comprises:
a carrying plate extending in the second horizontal direction, and
a guard plate extending in the vertical direction and coupled at a side of the carrying plate in the first horizontal direction and opposite to the alignment assembly;
wherein the alignment assembly comprises three rollers oriented in the vertical direction and spaced apart from one another in the second horizontal direction; and the three rollers are arranged at a side of the carrying plate opposite to the guard plate in the first horizontal direction.

3. The collecting device according to claim 2, further comprising:
a pressure assembly located at the object carrier in the first position and configured to generate pressure on a top of the object stack collected on the object carrier under gravity;
wherein the pressure assembly comprises:
a mounting plate defining two holes,
two cylinders slidably mounted in the two holes respectively, and
a pressing plate coupled to bottom ends of the two cylinders, the pressing plate being configured to generate pressure on the top of the object stack collected on the object carrier under gravity.

4. The collecting device according to claim 3, further comprising:
a guidance assembly located at the object carrier in the first position and configured to guide the at least one object transferred from the laser printer onto the object carrier.

5. The collecting device according to claim 4, further comprising a protection plate located at the object carrier in the first position and attached to at least one of the guide assembly or the pressure assembly, and configured to prevent retreat of the at least one object collected on the object carrier from the object carrier in the first horizontal direction.

6. The collecting device according to claim 1, further comprising:
a stack height sensor located at the object carrier in the first position and configured to determine whether a height of the object stack on the object carrier reaches a preset height.

7. The collecting device according to claim 1, wherein the first drive assembly comprises:
a first motor having an output end;
a first screw rod coupled to the output end;
a first nut fitted over the first screw rod, the first screw rod and the first nut being configured to translate turning motion of the first screw rod into linear motion of the first nut in the vertical direction, the first nut being coupled to the object carrier;
a first guide rail oriented in the vertical direction; and
a first slide block is slidably arranged on the first guide rail and fixedly coupled to the first nut.

8. The collecting device according to claim 1, wherein the first drive assembly comprises:
a first position sensor located at the object carrier in the first position;
a second position sensor located at the object carrier in the second position; and
a first trigger plate coupled to the object carrier and movable with the object carrier, and configured to trigger the first position sensor when the object carrier is in the first position and trigger the second position sensor when the object carrier is in the second position.

9. The collecting device according to claim 1, wherein the object carrier comprises:
a bearing plate extending in the first horizontal direction and configured to carry the at least one object from the laser printer, the bearing plate having a first end and a second end opposite to each other in the first horizontal direction, the at least one object being transferable onto the bearing plate from the first end; and
a coupling plate extending in the vertical direction and coupled to the second end of the bearing plate, and coupled to the first drive assembly,
wherein the bearing plate defines a slope surface at the first end of the bearing plate.

10. The collecting device according to claim 2, wherein the pushing member is movable between an original position and an end position in the second horizontal direction, wherein in the original position, the pushing member is located at a side of the object carrier in the second position away from the object stage, and in the end position, the pushing member is located on the object stage and beyond the alignment assembly.

11. The collecting device according to claim 10, wherein the second drive assembly comprises:
a third position sensor located at the pushing member in the original position;
a fourth position sensor located at the pushing member in the end position; and
a second trigger plate coupled to the pushing member and movable with the pushing member, and configured to trigger the third position sensor when the pushing member is in the original position and trigger the fourth position sensor when the pushing member is in the end position.

12. The collecting device according to claim 1, wherein the second drive assembly comprises:
a second motor having an output end;
a second screw rod coupled to the output end;
a second nut fitted over the second screw rod, the second screw rod and the second nut being configured to translate turning motion of the second screw rod into linear motion of the second nut in the second horizontal direction, and the second nut being coupled to the pushing member;
a second guide rail oriented in the second horizontal direction; and
a second slide block is slidably arranged on the second guide rail and fixedly coupled to the second nut.

13. A laser printer, comprising:
a collecting device according to claim 1;
a laser generator configured to laser-print an object; and
a printing area located below the laser generator in the vertical direction and configured to carry the object;
wherein the collecting device is located at a side of the printing area in the first horizontal direction.

14. A method for using a laser printer according to claim 13, comprising:
laser-printing an object and transferring the object to the object carrier to form an object stack on the object carrier; and
in response to determining that the object carrier is full or a single task of laser-printing a same type of objects is completed, unloading the object stack from the object carrier to the object stage.
